(19) United States
(12) Patent Application Publication
(10) Pub. No.: US 2014/0279353 A1
(43) Pub. Date: Sep. 18, 2014

(54) C2EX Compute Commodities Exchange

(71) Applicants: Shawn Patrick Findlan, Darien, CT (US); Johannes Rudolf Watzl, Aigen (AT)

(72) Inventors: Shawn Patrick Findlan, Darien, CT (US); Johannes Rudolf Watzl, Aigen (AT)

(21) Appl. No.: 13/864,880

(22) Filed: Apr. 17, 2013

Related U.S. Application Data
(60) Provisional application No. 61/799,382, filed on Mar. 15, 2013.

(51) Int. Cl. G06Q 40/04

(52) U.S. Cl. CPC G06Q 40/04
USPC 705/37

(57) ABSTRACT

A system for exchanging cloud computing resources in a market has a central computer, a client computer, at least one database containing a list of available cloud computing resources and a list of suppliers. Software executes on the central computer for receiving a request for a specific resource from the client computer. The central computer matches the request for a specific resource to the list of available resources. The central computer provides to the client computer a list of available resources that matches the request for a specific resource. The central computer then receives a buy request from a consumer of the specific resource and sends the request to a supplier of the specific resource.

### FIELD OF THE INVENTION

The present invention relates generally to a computing commodities exchange, and more specifically, relates to a cloud computing resource commodities exchange where suppliers and consumers can contract for available cloud computing resources.

### BACKGROUND OF THE INVENTION

As companies look to expand their revenue sources, non-traditional sources have been sought out that can produce a large profit, with little overhead. One area of attraction is to utilize existing resources to produce a new revenue stream. Any profit derived from these existing resources is mostly profit, as the resource has already been purchased. Additionally, these alternative revenue streams can help pay for the existing resources.

One specific, non-traditional, area is computing resources. Many companies have invested large amounts of capital in large computing systems. Systems can include large processing capabilities, storage capabilities, or any other type of computing based resource. These systems generally require a large amount of capital to create, and a relatively large amount capital to maintain; however, much of the time, these systems remain dormant. For example, a company may only utilize a portion of the available resources at any given time. A company may require the entire resource for a small amount of time, but most of the time the resources are underutilized. By renting out the underutilized resources companies can recoup some of their investment, and can recoup some or all of the capital required to maintain the resources. In some cases, the company can produce a profit based on their available resources.

While companies may be eager to rent out their unused resources, it can be very difficult to find a consumer of these resources. Companies can try to advertise the available resources in a trade magazine, or other traditional source of advertising mechanism, however, these mechanisms are traditionally very slow, meaning that by the time a consumer views the advertisement and decides to rent the available resource, that resource may no longer be available.

To overcome this problem, small markets for available resources have been created. For example, U.S. Patent Publication No. 2010/0088205 to Robertson discloses a system for allocating resources in a cloud computing spot. A user wishing to access the available computer resources queries the cloud computing spot market. The market allocates the necessary resources, and may request additional resources for the user depending on the available resources not already in the market, and the needs of the user. A problem with this type of system, is the system automatically allocates available resources to the user. The user does not have the capability to receive a list of available resources, and separately contract for a resource, and with a supplier of their choosing.

U.S. Patent Publication No. 2008/0080396 Meijer et al. discloses a marketplace for cloud computing resources. A client device sends a request to an interface component. The interface component dynamically apportions the necessary resources supported by a third party, and responds based in part on subscription data of the client device. A problem with this system is the user is required to have a subscription to the marketplace, and the number of resources allocated to the user is dependent on the subscription plan that the user subscribes to.

A disadvantage of these known marketplaces is users may be required to sign up for a subscription service. Therefore, a user would need to pay a fee even if they don't currently require cloud computing resources. Another disadvantage of these known marketplaces is that the user is automatically assigned a resource that is available. The user is at the mercy of the supplier, and the marketplace itself, for the number of available resources, and the price per resource. Another disadvantage of these known marketplaces is that the resources are traded as if each resource is the same. Each class of resource is normalized, preventing different resources from commanding different prices depending on their scarcity. Another disadvantage is that once a supplier lists their available resources, they are at the mercy of the system for the resources to be allocated. They have no say in the number of resources to be given to a particular supplier, or the price per resource.

What is desired, therefore, is a cloud computing exchange that allows suppliers to list their available resources, and consumers to search the available resources and receive a list of the available resources. The supplier and the consumer can then separately contract for the number of resources and the price per resource.

### SUMMARY OF THE INVENTION

The invention is directed to a cloud computing resource exchange market. The market allows a supplier to list their available resources and for a consumer to query the system and receive a list of available resources. The consumer can then communicate with the supplier to negotiate a contract for the resources to be consumed.

These and other objects of the present invention are achieved by provision of a system for exchanging cloud computing resources in a market comprising a central computer, a client computer, at least one database containing a list of available cloud computing resources and a list of suppliers. Software executes on the central computer for receiving a request for a specific resource from the client computer. The central computer matches the request for a specific resource to the list of available resources. The central computer provides to the client computer a list of available resources that matches the request for a specific resource. The central computer then receives a buy request from a consumer of the specific resource and sends the request to a supplier of the specific resource.

In some embodiments of the present invention, a contract is sent to the consumer if the supplier and the consumer successfully negotiate the contract. In some embodiments of the present invention, the computing resource is one of an EC2 compute unit, an S3 storage unit, a Joyent compute unit, an Enomaly compute unit, a Hadoop unit, a Monte-Carlo unit, a rendering unit, a Google apps unit, and a proprietary computing algorithm. In some embodiments of the present invention, the available computing resource is based on a number of units and a time the units are available for. In some embodiments of the present invention, the consumer inputs a set of parameters and a matching system matches the available resource to a set of parameters. In some embodiments of the present invention, the supplier lists their available resources with a broker and the consumer queries the broker for the specific computing resource. In some embodiments of the present invention, the contract details a number of units negotiated for and an amount of time the consumer can consume the specific resources.

In some embodiments of the present invention, the amount of time can be broken up into separate time units to be used at different times. In some embodiments of the present invention, the contract includes a plurality of different types of resources. In some embodiments of the present invention, the contract includes a quality of service standard and a priority at which the consumer can consume the specific resource. In some embodiments of the present invention, a rating agency can rate the supplier of the resources. In some embodiments of the present invention, a plurality of suppliers register a plurality of available resources. In some embodiments of the present invention, a ticker showing prices of available commodities is displayed to the consumer. In some embodiments of the present invention, the consumer can query a specific supplier to see all available resources from that supplier. In some embodiments of the present invention, the consumer can resell a part of or the entire contract. In some embodiments of the present invention, the matching includes determining if the resource requested is available on the list of available resources and providing to the consumer the list of available resources that match the request if the resource is available.

In another embodiment of the present invention is a method of exchanging cloud computing resources through a market comprising receiving a list of at least one cloud computing resource, storing the list of the at least one cloud computing resource in a list of available resources, and receiving a request from a consumer for a resource. The request from the consumer for the resource is matched to the list of available resources. The consumer is provided a list of available resources that match the request. A buy request is received from the consumer for a specific available resource. The buy request is sent to the supplier of the specific available resource.

In some embodiments of the present invention, a contract is negotiated between the supplier and the consumer. In some embodiments of the present invention, the contract is sent to the supplier and the consumer. In some embodiments of the present invention, a payment is received from the supplier and the consumer. In some embodiments of the present invention, the computing resource is one of an EC2 compute unit, an S3 storage unit, a Joyent compute unit, an Enomaly compute unit, a Hadoop unit, a Monte-Carlo unit, a rendering unit, a Google apps unit, and a proprietary computing algorithm. In some embodiments of the present invention, the available computing resource is based on the number of units and the amount of time the units are available for. In some embodiments of the present invention, the request for the available resources includes a set of parameters and a matching system matches the available resource to the set of parameters.

In some embodiments of the present invention, the supplier lists their available resources with a broker and the consumer queries the broker for the specific computing resource. In some embodiments of the present invention, the contract details the number of units negotiated for and an amount of time the consumer can consume the specific resource. In some embodiments of the present invention, the amount of time can be broken up into separate time units to be used at different times. In some embodiments of the present invention, the contract includes a plurality of different types of resources. In some embodiments of the present invention, the contract includes a quality of service standard and a priority at which the consumer can consume the specific resource. In some embodiments of the present invention, a rating agency can rate the supplier of the resources. In some embodiments of the present invention, a plurality of suppliers register a plurality of available resources. In some embodiments of the present invention, a ticker showing the prices of available commodities is displayed to the consumer. In some embodiments of the present invention, the consumer can query a specific supplier to see all available resources from that supplier. In some embodiments of the present invention, the matching includes determining if the resource requested is available on the list of available resources and providing to the consumer the list of available resources that match the request if the resource is available.

### BRIEF DESCRIPTION OF THE DRAWINGS

FIG. 1 is a schematic of a system for exchanging cloud computing resources.

FIG. 2 illustrates an exemplary method of a buyer searching for available resources on the exchange system according to FIG. 1.

FIG. 3 illustrates an exemplary method of a supplier making their resources available on the exchange system according to FIG. 1.

### DETAILED DESCRIPTION OF THE INVENTION

The exemplary embodiments of the present invention may be further understood with reference to the following description and the related appended drawings, wherein like elements are provided with the same reference numerals. The exemplary embodiments of the present invention are related to an exchange for cloud computing resources. Specifically, the exchange allows for a supplier to list their available resources, and for a consumer to query the system and receive a list of all the available resources that match their request, and all the available suppliers. The supplier and the consumer can then negotiate a contract for the available resource.

The term exchange used in this document can include the exchange marketplace, clearing services, settlement services, and/or rating agencies.

The clearing can be covered by the exchange. Additionally, other companies may offer clearing services for cloud computing commodities and their derivatives.

Entities offering a clearing service may ask for margin deposits and may provide insurance for non-payment and non-delivery of a service. Insurance services can also be offered by independent insurance companies.

Insurance mechanisms for long term contracts can be realized either on the basis of financial instruments similar to credit default swaps or offered by insurance companies. These instruments might include penalties which have to be paid by the provider in case of non-delivery of a service. This can also be compared to the physical commodity trading terms of “CIF” or “Cost Insurance Freight,” which in the case of this concept would mean delivery of the compute resource and insurance against the delivery or lack thereof of that resource. (http://en.wikipedia.org/wiki/lncoterms)

For providing settlement services it is necessary for providers to deposit access information (i.e. URL, credentials) for a service offer prior to the usage start time at an entity offering settlement services. To avoid the bottleneck of the settlement several settlement services are available providing the settlement of one or more providers.

As best seen in FIG. 1, a schematic of a cloud computing exchange system 100 is shown. Exchange 100 includes an exchange server, or central computer, 105. Exchange server 105 can be a stand-alone server or housed in a rack. Preferably, exchange server 105 includes a processor, a memory, an input/output system, and a connection to a network. Exchange server 105 may have a monitor, keyboard, and mouse connected directly to it, or exchange server 105 may be remotely accessed in order to be programmed or modified. In the embodiment shown, the exchange is stored on a single exchange server, such that all commodities are controlled on the exchange server, however, multiple exchange servers can be networked together allowing for individual or subgroups of commodities to be controlled by multiple exchange servers. If one exchange server receives a request for a commodity that it does not control, it may request that commodity from another exchange server. In this type of setup, the user may or may not be aware that different exchange servers are being employed. Additionally, multiple exchange servers may be setup such that there is at least one backup to the main exchange server. In case of a failure in the main server, a backup server can seamlessly take over running the exchange without any interruptions to the end users. Exchange servers may exist for different legal domains.

Exchange server 105 offers a cloud computing exchange service. The cloud computing exchange service allows for the trading of different cloud computing resources. Cloud computing resources can include an EC2 compute unit, an S3 storage unit, a Joyent compute unit, an Enomaly compute unit, a Hadoop unit, a Monte-Carlo unit, a rendering unit, a Google apps unit, a general storage or computing unit, and a proprietary computing algorithm. Any cloud computing resource can be traded on the exchange service, and as new resources are invented, these resources can also be traded on exchange system 100. Additionally, as new types of commodities become available, the exchange system is not required to have any knowledge of these types of resources. The seller of the resource can create a new category for the resource without the need for someone to reconfigure exchange 100.

An exchange traded cloud computing commodity or cloud service is described by service parameters (i.e. Infrastructure parameters like CPU speed or available RAM or available software or execution platforms), a way to access it (i.e. an API), a set of benchmarks, and the minimum benchmark result necessary to offer resources as this commodity.

For certain services, the trading of time units or transactions is not feasible. For these services another concept is introduced, namely benchmark units. For these services traded on the exchange, a benchmark or a set of benchmarks is provided. To be able to submit an offer, a minimum benchmark result which is defined for this service has to be achieved by the service intended to offer.

With benchmark units it is on the one hand possible to guarantee a minimum quality level of a service and it enables on the other hand the trading of benchmark units. This means a function is defined returning a number of benchmark units computed with a benchmark result as input.

Cloud commodities are a non-storable good. Thus, the trading will be done in future, day-ahead (i.e. hourly buckets of a cloud commodity), and spot markets.

Exchange server 105 stores a list of available resources. The list of available resources includes the type of unit, the number of units, the amount of time the units are available for, and the provider of the resource. The provider of the resource may be supplier 110, or broker 130 (described in detail below). The list of available resources may be stored directly on exchange server 105, or exchange server 105 may be connected to an external database 130. The list of available resources is searchable and sortable. For example, the list of available resources can be sorted by supplier or type of unit. The list can be further sorted by, for example, nested sorting, such that the list is sorted by supplier, then by type of unit, and then by number of resources available. Sorting of the list of available resources allows the user supporting the exchange to monitor which resources are in high capacity, which resources are in low capacity, which suppliers list a large amount of resources, and other types of information about the available resources currently listed on the exchange.

Exchange server 105 is connected to a network 125. Network 125 may be a wired or wireless network. Network 125 allows for communication between exchange server 105 and a supplier, a consumer, or a broker. Network 125 is robust enough to handle multiple communications from different suppliers, different consumers, and different brokers. Additionally, network 125 allows exchange server 105 to communicate with other exchange servers that may house different resources or may be used as a backup.

Exchange server 105 can be connected, over network 125, to a supplier 110. Supplier 110 has cloud computing resources 115 that may be unutilized or underutilized. In order to recoup some or all of the costs of the computing resources 115, or to generate an additional profit, supplier 110 may elect to make the resources 115 available to a consumer at a cost. Rather than attempt to find a consumer on its own, supplier 110 can communicate with exchange server 105 to list their available resources. The list of available resources may be static, such that the supplier lists a finite amount of resources 115, on one occasion, with exchange server 105. Supplier 110 may also dynamically update their available resources 115 as resources 115 become available or unavailable. For example, supplier 110 may only currently have storage units available, and as such only lists these storage units with exchange server 105. However, at a late date, processing units may become available, which may then be listed on the exchange.

The exchange 100 may set minimum standards for each supplier. For example, exchange 100 may set minimum delivery standards, a minimum number of resources to be made available, or any other type of parameters. Setting minimum standards allows for some control over the resources listed, allowing the exchange to build a more robust and trusted exchange.

When supplier 110 sends the lists of available resources to exchange server 105, the supplier sends the different types of resources available, the number of available resources for each type, the amount of time the resources should be displayed as available on the exchange, and the amount of time each resource can be utilized. Supplier 110 may also list whether the amount of time the consumer can utilize the resource is consecutive, or whether the time may be broken up. Any or all of this information can be dynamically updated as the resources 115 change.

Exchange server 105 receives the list of available resources 115 and stores it in a database. The list of available resources 115 is searchable, and thus can be easily sorted and made available for a consumer. In the embodiment shown, a single supplier lists their available resources on the exchange; however, multiple suppliers can list multiple resources on the exchange.

When a supplier 110 lists their available resources 115 on the exchange, they list a price per resource. The price is set by the supplier, but like a traditional exchange, is subject to market forces. For example, a good or a poor rating (described below) may affect the price of the resource. If the resource is scarce then supplier 110 may be able to command a higher price for the resource. Conversely, if the resource is abundant, the price may be lower. Many factors can affect the final price of the resource, including the negotiation of the contract (described below).

Consumer 120 is in communication with exchange server 105 over network 125. Consumer 120 contacts exchange server 120 with a request to consume resources. If consumer 120 knows which particular computing resource they want to consume, consumer 120 queries exchange server 105 for the specific resource. The query may include the number of units requested and the amount of time requested for. If no units of that specific resource are available, the system sends a response to the consumer that the resources are unavailable. If the resource is available, but the number of resources is not sufficient for the request, exchange server may send a response detailing the number of units available.

If any of the requested resources is available, consumer 120 will receive a list of all of the available resources, of the specific type requested, including the supplier of the resources. If the resource is available from multiple suppliers, a list of all the suppliers and their number of resources is displayed. In reviewing the list of available resources, and suppliers, consumer 120 may elect to use a single supplier 110 for all of the requested resources. Consumer 120 may also elect to use multiple suppliers, especially in a case where no single supplier can supply all of the requested units.

If consumer 120 does not require a specific type of resource, for example, when multiple types of resources can be used, the consumer can select multiple types of resources to search for. A search will produce all of the available types of resources, the number of available resources for each type, and the suppliers of all of the resources. Consumer 120 can sort the received list to more easily determine which resource and which supplier to use.

Consumer 120 may also elect to input parameters into the exchange, without specifying the type of resource. If consumer 120 does not know which resource suits their needs, a consumer only needs to list what is required of the resource. Exchange server 105 can receive the requested parameters and automatically match the parameters to the resources listed on exchange 100. Exchange server 105 then provides to consumer 120 a list of all of the available resources that match the requested parameters. Consumer 120 can then choose which resource to consume based on the number of available resources, the price, and the supplier. It should be noted that in the embodiment shown there is only a single consumer 120 in communication with exchange server 105, however, multiple consumers can communicate and query exchange server 105.

In addition to querying exchange 105 for a specific resource, consumer 120 can query exchange 105 for a specific supplier 110. If consumer 120 has worked with supplier 110 in the past, and had a favorable experience with them, consumer 110 may elect to forego a search of all suppliers for the specific resource by determining if the resource is available from a specific supplier 110. Consumer 120 can query exchange 105 for supplier 110 and receive a list of all available resources 115 which supplier 110 has available.

Along with the list of available resources, supplier information is provided. The supplier information may include the name of the supplier, the location of the supplier, a rating of the supplier, and other supplier information. The rating may be done by a ratings agency based on the quality of service, or other parameters, of the supplier. Additionally, there may be a consumer rating of the supplier. Consumers may rate the supplier on a scale of 1 to 10, or on a 5 star system, or any other known type of ratings system. Consumers may also be allowed to enter in specific comments about the supplier. A positive or a negative rating of a supplier may raise or lower the price they can command for the resource.

Providers are rated according their financial health and monitoring data (i.e. Service Level Agreement—SLA violations) by rating agencies. In addition, user ratings (reflecting overall user satisfaction with a provider) are taken into account. Therefore, the provider rating is done on the basis of a hybrid model including the centralized rating agency ratings and the distributed user ratings. User ratings might be obtained using social network relations between users to antagonize fraud.

Based on the provider ratings, subcommodities are introduced. A subcommodity is a cloud computing commodity with a rating extension (i.e. AAA). On the exchange the commodities are traded in rating classes. Providers with a certain rating are allowed to place bids on this commodity only in the subcommodity of their current rating (or below).

To access exchange server 105, consumer 120 may use a browser-based interface to access the features of the exchange. Additionally, a stand-alone program may be used to specifically interface with the exchange. The stand-alone program may run on a standard pc or Mac, or the program may be an application programmed specifically for the mobile market including tablets, mobile phones, smart phones, and any other type of portable product. If a user accesses exchange 105 using an application, a resource ticker, either embedded in the application or as a plug-in in the computer software may be available. The ticker may show a rotating list of all available resources, or the user may select which resources are displayed on the ticker.

The exchange may also be accessible via an automated phone system, such that a consumer can call exchange server 105 to get a list of available resources and select an available resource. Finally, a user may use an SMS, or short message service, to query exchange server 105. It should be noted that the above methods of accessing exchange servers is not exhaustive, and as new modes of communication become available, these methods may be incorporated to allow access to the exchange.

Once consumer 120 decides which resource, and which supplier to consume the specific resource from, exchange 105 notifies supplier 110 that a request for the specific resource has been made. Supplier 110 may then receive the request from consumer 120, including the type of resource the number of resources, and the amount of time the resources are requested for. Based on this information, supplier 110 may or may not elect to supply their resources to consumer 120. Supplier 110 may ask for additional information from consumer 120, including what type of data or processing may be performed. This may or may not affect supplier 110's decision to supply their resource 115 to consumer 120.

If supplier 110 elects to supply their resources 115 to consumer 120, a contract is negotiated between supplier 110 and consumer 120. The contract may include the number of units to be consumed, the amount of the time the units are to be consumed for, including whether the time is consecutive or can be split up, when the resources have to be consumed by, the quality of service and priority that will be afforded to consumer 120, and whether the contract can be resold either in whole or in part. Additional parameters of the contract, including standard contract clauses may be included in the contract. Additionally, if a supplier 110 has multiple types of resources to be consumed by consumer 120, a single contract may be used for all of the resources, or multiple contracts may be negotiated, one for each type of resource.

Once a contract has been finalized, a copy of the contract is stored on exchange 105, and a copy is sent to supplier 110 and consumer 120. Upon the completion of a contract, both supplier 110 and consumer 120 remit payment to the exchange. The payment may be a fixed payment per contract, or be dependent on the type of resources, and the number of resources that are contracted for. Payments and fee schedules will be known to supplier 110 and consumer 120, and may be updated as needed. In addition to a fee after the contract is negotiated, a fee may be charged to supplier 110 to list the resources on the exchange, and a fee may be charged to consumer 120 to be able to search the exchange. Fees charged to supplier 110 may be based on a one-time listing, or may be ongoing, such as monthly basis, depending on how long the resources are available for. Additionally, the fee charged to consumer 120 may be a one-time basis, or an ongoing subscription fee may be charged, such as a monthly fee.

If a contract allows for the resale of all or part of the contract, a consumer 120 can elect to list the resources on the exchange, becoming a supplier. For example, if a consumer 120 negotiates a contract for 40 storage units, but ends up only needing 10, the consumer 120 may list the remaining 30 units on the exchange. Consumer 120 may elect to list all of the units contracted for on the exchange. In the exchange, contracts can be traded like financial instruments, similar to the energy industry. The exchange can act as a traditional exchange market including derivatives, futures, and options.

In the preferred embodiment above, supplier 110 and consumer 120 communicate directly with exchange server 105. However, a broker 135, or a middleman, may also be used. Supplier 110 may list their resources 115 with broker 135, which will list the resources 115 with the exchange. By listing their resources 115 with broker 135, supplier 110 does not need to communicate with exchange server 105, or negotiate a contract with consumer 120. This may make the process a lot easier for supplier 110.

Consumer 120 may also use a broker 135 to request a resource. Consumer 120 may send a request to broker 135 with all of the required information for the resource to be consumed. Broker 135 may query exchange server 105 to find the available resource, and to negotiate a contract with supplier 110 on consumer 120's behalf. The broker used by supplier 110 and consumer 120 may be the same broker, or multiple brokers may be used.

A broker 135 can act as a supplier, a consumer, or as both. They have access to the same information as a stand-alone supplier or consumer, and may act similar to a stock broker in a traditional stock exchange system. Once broker 135 brokers a deal between supplier 110 and consumer 120, or between another broker if a second broker is used, a contract is sent to supplier 110, to consumer 120, and to the exchange. Broker 135 may then request a fee from supplier 110 and consumer 120. The fee may be a flat fee per contract, or the fee may be based on the number and type of resources contracted for.

As best seen in FIG. 2 an exemplary method of a consumer searching for available resources on the exchange system according to FIG. 1 is shown. At step 205 the consumer decides that they need cloud computing resources. The consumer may have no computing resources at their disposal, and may need to contract for all of their resources or the consumer may have some resources at their disposal, requiring additional resources. At step 210 the consumer determines what resources they need, including the amount of resources needed, or the parameters required for the exchange to match a specific resource to. At step 215 the consumer decides whether to use a broker. If the consumer decides to a use a broker, the consumer sends their needs to the broker at step 240. At step 245 the broker determines if the resource requested is available on the exchange. If the resource requested is not available then the request ends at step 260. If the resource is available, a contract is negotiated for the resource, by the broker, and a contract is sent to the consumer at step 250. At step 255 a fee is paid for the service. The consumer may pay one fee to the broker, and the broker may pay a fee to the exchange, or the consumer may pay a fee to the broker and to the exchange. Once the fee has been paid, the search ends.

If, at step 215, a broker is not used, the consumer searches the exchange at step 220. If a match 225 is not found then the search ends at step 260. If a match 225 is found, the consumer makes an offer or a bid to the supplier at step 230. If the offer or bid is not accepted at step 235, then the consumer may make a new offer at step 230. If the offer is accepted at step 235 then a contract is received by the supplier and the consumer at step 250. The consumer and the supplier pay a fee to the exchange at step 255, and the search ends at step 260.

As best seen in FIG. 3, an exemplary method of a supplier making their resources available on the exchange system according to FIG. 1 is shown. At step 305 the supplier decides to list their available resources on the exchange. The supplier may list a single resource or may list multiple types of resources. At step 310, all of the resources to be listed are chosen. At step 315, the supplier decides whether or not to list their resources with a broker. If the supplier decides to list with a broker, then a list of the resources to be made available is sent to the broker 335. The broker lists the resources on the exchange and negotiates a contract on behalf of the supplier. If a consumer does not express interest in the resource, the supplier may cancel the listing with the broker at step 340 and the listing ends at step 355. If the broker successfully negotiates a contract for the resource, a contract is sent to the supplier at step 345. At step 350 a fee is paid. A single fee may be paid to the broker, who also pays a fee to the exchange, or the supplier may pay a fee to the broker and to the exchange. Once the fee has been paid, the listing ends at step 350.

If at step 315, the supplier elects not to list with a broker, the supplier lists the resource directly on the exchange at step 320. If the supplier does not receive an offer or a bid at step 325, the supplier may elect to cancel their listing at step 355. If the supplier receives and offer at step 325, but the offer is not accepted at step 330, then a negotiation may occur until the offer is accepted. Once the offer is accepted at step 330 a contract is received by the supplier and the consumer at step 345. At step 350 both the supplier and the consumer pay a fee to the exchange and the listing ends at step 360.

In one embodiment of the present invention, the exchange system 100 is configured to offer one or more applications, also referred to as virtual machine images (“VM images”) to the a consumer 105. This functionality may be referred to as an Analytics Store. In certain embodiments, the Analytics Store comprises an interface that is made available via the exchange server 105. A supplier 110 can communicate with the exchange server 105 and offer one or more VM images to consumer 120.

In some embodiments, the Analytics Store made available via the exchange server 105 includes an interface through which a consumer can request an infrastructure built up by different Cloud resources, such as VM images, offered by suppliers 110 on the exchange 105. For example, an infrastructure may contain two clusters each based on a certain VM image and a SaaS component. Through this interface, a consumer is able to create workflows by picking parts from different providers including IaaS, PaaS, SaaS, and the consumer is able to run VM image templates offered in the Analytics Store on the IaaS resources. The level of detail of the requests varies from simple users not caring about technical details to advanced users who want to specify certain (infrastructure, size, location, network interconnect, CPU, etc) details.

In one embodiment of the present invention, the Analytics Store comprises a pool of virtual machine images. Any company, individual person, or institution can offer VM images which are able to solve certain problems or provide specific features. For example the VM images may include, but are not limited to Webserver, Hadoop, Monte Carlo, Matlab, Mathematica, RenderMan, Grid on Cloud, Operating Systems.

In some embodiments of the present invention, the VM images may be checked by a third party. If the VM image satisfies the check, it is awarded a trusted status. Such quality checks may be performed periodically after the initial check and in case of security issues to upgrade or deprecate a VM image. If a consumer deploys a VM image, the creator of the VM image (i.e. the supplier 100) receives a certain amount of money and the operator of the system may receive a predetermined amount of money. This embodiment enables a broad range of new marketing strategies for the software business (ie. license fees per image deployment). The price per hour for the requested infrastructure is composed of the commodity price plus VM image license fees.

This exchange has many advantages over prior art markets. First, the resources listed on the exchange are not normalized. Each resource is considered a separate commodity and treated differently. Each resource has its own pricing structure, and the price of each resource can fluctuate independently of other resources. Prior art markets normalized the available resources, preventing a true exchange from being formed. The exchange also allows the supplier and the consumer to separately negotiate a contract for resource. For example, the negotiation can include whether or not the contract can be resold, either in whole or in part, or the contract can set whether the cloud computing units must be used consecutively or at different times. None of which is allowable by prior art markets.

It would be appreciated by those skilled in the art that various changes and modification can be made to the illustrated embodiment without departing from the spirit of the invention. All such modification and changes are intended to be covered hereby.

What is claimed is:

1. A system for exchanging cloud computing resources in a market comprising:
a central computer;
a client computer;
at least one database containing a list of available cloud computing resources and a list of suppliers;
software executing on said central computer for receiving a request for a specific resource from said client computer;
software executing on said central computer for matching said request for a specific resource to said list of available resources;
software executing on said central computer for providing to said client computer a list of available resources that matches said request for a specific resource;
software executing on said central computer for receiving a buy request from a consumer of said specific resource and sending said request to a supplier of said specific resource.

2. The system of claim 1, wherein a contract is sent to said consumer if said supplier and said consumer successfully negotiate said contract.

3. The system of claim 1, wherein said computing resource is one of an EC2 compute unit, an S3 storage unit, a Joyent compute unit, an Enomaly compute unit, a Hadoop unit, a Monte-Carlo unit, a rendering unit, a Google apps unit, and a proprietary computing algorithm.

4. The system of claim 1, wherein said available computing resource is based on a number of units and an amount of time said units are available for.

5. The system of claim 1, wherein said consumer inputs a set of parameters and a matching system matches said available resource to a set of parameters.

6. The system of claim 1, wherein said supplier lists their available resources with a broker and said consumer queries said broker for said specific computing resource.

7. The system of claim 1, wherein said contract details a number of units negotiated for and an amount of time said consumer can consume said specific resource.

8. The system of claim 7, wherein said amount of time can be broken up into separate time units to be used at different times.

9. The system of claim 1, wherein said contract includes a plurality of different types of resources.

10. The system of claim 1, wherein said contract includes a quality of service standard and a priority at which said consumer can consume said specific resource.

11. The system of claim 1, wherein a rating agency can rate said supplier of said resources.

12. The system of claim 1, wherein a plurality of suppliers register a plurality of available resources.

13. The system of claim 1, wherein a ticker showing prices of available commodities is displayed to said consumer.

14. The system of claim 1, wherein said consumer can query a specific supplier to see all available resources from that supplier.

15. The system of claim 1, wherein said consumer can resell a part of or all of said contract.

16. The system of claim 1, wherein said matching includes determining if said resource requested is available on said list of available resources and providing to said consumer said list of available resources that match said request if said resource is available.

17. A method of exchanging cloud computing resources through a market comprising:
receiving a list of at least one cloud computing resource;
storing the list of the at least one cloud computing resource in a list of available resources;
receiving a request from a consumer for a resource;
matching the request from the consumer for the resource to the list of available resources;
providing to the consumer a list of available resources that match the request;
receiving from a consumer a buy request for a specific available resource;
sending the buy request to the supplier of the specific available resource.

18. The method of claim 17, wherein a contract is negotiated between the supplier and the consumer.

19. The method of claim 18, wherein the contract is sent to the supplier and the consumer.

20. The method of claim 17, wherein a payment is received from the supplier and the consumer.

21. The method of claim 17, wherein the computing resource is one of an EC2 compute unit, an S3 storage unit, a Joyent compute unit, an Enomaly compute unit, a Hadoop unit, a Monte-Carlo unit, a rendering unit, a Google apps unit, and a proprietary computing algorithm.

22. The method of claim 17, wherein the available computing resource is based on the number of units and the amount of time the units are available for.

23. The method of claim 17, wherein the request for the available resource includes a set of parameters and a matching system matches the available resource to the set of parameters.

24. The method of claim 17, wherein the supplier lists their available resources with a broker and the consumer queries the broker for the specific computing resource.

25. The method of claim 17, wherein the contract details the number of units negotiated for and an amount of time the consumer can consume the specific resource.

26. The method of claim 25, wherein the amount of time can be broken up into separate time units to be used at different times.

27. The method of claim 17, wherein the contract includes a plurality of different types of resources.

28. The method of claim 17, wherein the contract includes a quality of service standard and a priority at which the consumer can consume the specific resource.

29. The method of claim 17, wherein a rating agency can rate the supplier of the resources.

30. The method of claim 17, wherein a plurality of suppliers register a plurality of available resources.

31. The method of claim 17, wherein a ticker showing the prices of available commodities is displayed to the consumer.

32. The method of claim 17, wherein the consumer can query a specific supplier to see all available resources from that supplier.

33. The method of claim 17, wherein the matching includes determining if the resource requested is available on the list of available resources and providing to the consumer the list of available resources that match the request if the resource is available.
